(19) United States
(12) Patent Application Publication
(10) Pub. No.: US 2010/0082569 A1
(43) Pub. Date: Apr. 1, 2010

(54) AUTOMATED SYSTEM AND METHOD FOR NOTIFYING A SERVICE PROVIDER OF THE ARRIVAL OF A VEHICLE

(76) Inventors: George CRESTO, Marietta, GA (US); Darryl Hubbard, Smyrna, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/566,474

(22) Filed: Sep. 24, 2009

Related U.S. Application Data
(60) Provisional application No. 61/099,572, filed on Sep. 24, 2008.

(51) Int. Cl. G06F 17/30

(52) U.S. Cl. 707/705; 707/E17.107

(57) ABSTRACT

A system, method, and computer readable medium for notifying a service provider of the arrival of a vehicle is disclosed. The system includes an RFID reader that determines a unique vehicle code that is embedded with an RFID tag secured in or on the arriving vehicle and that transmits the unique vehicle code to a computer system. The computer system accesses a database for customer and vehicle information that corresponds to the unique vehicle code and transmits the customer and vehicle information to a remote user device.

### CROSS-REFERENCE TO RELATED APPLICATION

This application claims the benefit of U.S. Provisional Patent Application Ser. No. 61/099,572, filed Sep. 24, 2008, the entirety of which is hereby incorporated herein by reference.

### FIELD OF INVENTION

The present application relates generally to an automated system and method for notifying a service provider of the arrival of a vehicle entering a service area.

### SUMMARY

Advantageously, a method of the present invention notifies a service provider of the arrival of a vehicle. The method includes the steps of determining a unique vehicle code that is associated with the arriving vehicle; transmitting the unique vehicle code to a computer system having an associated database; accessing data (such as data related to the vehicle and/or customer) stored in the database that corresponds to the unique code; and displaying the data on a display screen. The display screen can be a display screen of a remote user device (such as computer, video screen, or cellular phone). Thus, an email, text message, or other pop-up message can be sent to the remote user device. Preferably, the step of determining a unique code further includes determining the unique code encoded in a radio frequency identification tag secured to or within the vehicle.

In another form, a system of the present invention notifies a service provider of the arrival of a vehicle. The system includes a radio frequency identification (RFID) reader having an associated transceiver, wherein the RFID reader receives a transmission of a unique vehicle identification code (such as a vehicle identification number or other unique number) from an RFID tag that is secured to the vehicle. The system further includes a computer system, wherein the computer system receives the unique code transmitted from the RFID reader, accesses a database for data associated with the unique code, and displays the associated data on a display device, wherein the displayed data includes data about the customer and/or vehicle associated with the unique code. The display device can include a display screen, a computer, a cellular phone, or a personal digital assistant. Optionally, the system can include a video camera that captures images and/or video of the vehicle and streams the images and/or video to the display device and a remote computer system that communicates with the computer system via a wireless communications network to access data in the database.

In another form, the present invention provides a computer readable medium having a computer program for notifying a service provider of the arrival of a vehicle, the program comprising executable instructions for determining a unique vehicle code that is associated with the arriving vehicle, transmitting the unique vehicle code to a computer system having an associated database, accessing data stored in the database that corresponds to the unique code, and displaying the data on a display screen.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE FIGURES

FIG. 1 is a schematic diagram of a system for notifying a service provider of the arrival of a vehicle according to an example embodiment of the present invention.

FIG. 2 is a schematic diagram of a computer server that can be used with the system of FIG. 1.

FIG. 3 is a flow diagram of a method for notifying a service provider of the arrival of a vehicle using the system of FIG. 1 according to an example embodiment of the present invention.

FIG. 4 is a flow diagram of a routine for displaying information to a user of the system of FIG. 1.

FIG. 5 is a flow diagram of a routine for adding a new customer to the database of FIG. 1.

FIG. 6 is a flow diagram of a routine for updating the database of FIG. 1.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Although the subject matter of the application is being described in the context, it is not meant to be limiting as those of skill in the art will appreciate that some of the acts and operations described hereinafter can also be implemented in hardware, software, and/or firmware and/or some combination thereof.

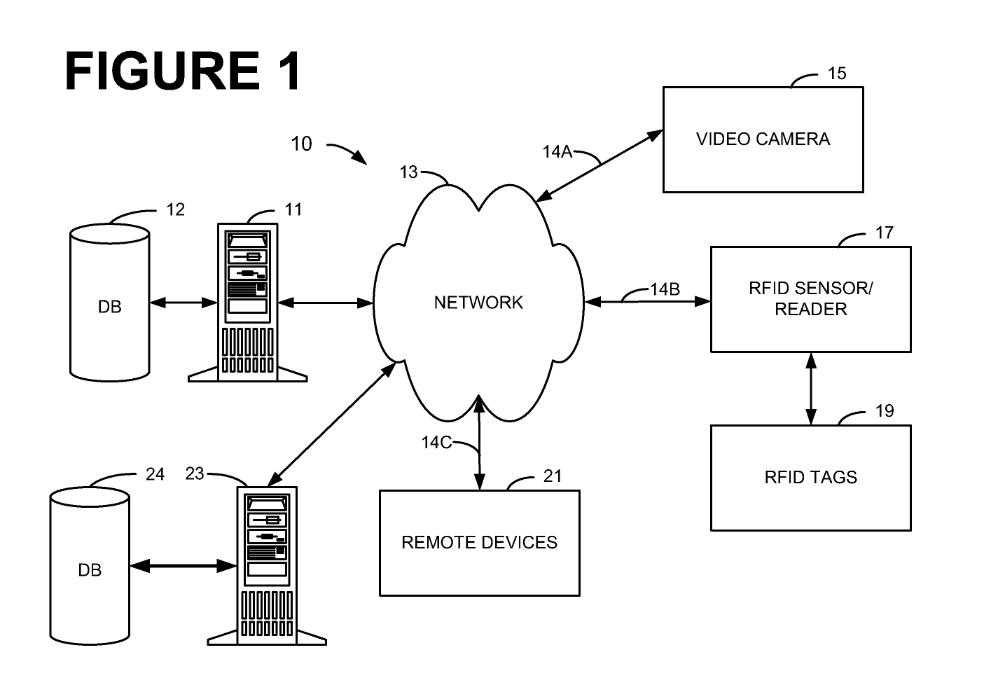

Referring now to the drawings, in which like numerals illustrate like elements throughout the several views, FIG. 1 illustrates a system for notifying a service provider of the arrival of a vehicle 10 according to an example embodiment of the present invention. Preferably, the system 10 includes a server or computer 11, a radio frequency identification (RFID) sensor/reader 17 for reading one or more RFID tags 19 secured to one or more vehicles, and one or more remote (or user) devices 21. The remote (or user) devices can include, but are not limited to, personal computers (PCs), workstations, laptops, handheld computer, pocket PCs, personal digital assistants (PDAs), pagers, WAP devices, non-WAP devices, cell phones, palm devices, printing devices, and display devices (such as plasma or LCD screens). The system 11 can optionally include a video camera 15. The RFID sensor 17, the remote devices 21, and the video camera 15 and are coupled to the server 11 via a network 13 and associated connections 14A-14C. The network 13 can include, but is not limited to, the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 can also be connected to the local area network (LAN) within an organization. Preferably, this system 10 is utilized by a vehicle dealership, mechanic's garage, or any other service provider. For example, such other service provider can include a restaurant (such as a drive-thru restaurant or carry-out service), catering service, retail service, or any other provider offering a service.

Each RFID tag 19 is preferably incorporated into a vehicle. Preferably, the RFID tag is a passive RFID tag, but in alternative embodiments, an active RFID tag or a battery assisted passive (BAP) RFID tag can be used. RFID tags are generally well known, and thus, their configurations will not be described herein. A vehicle can include a car, truck, SUV, boat, motorcycle, bus, or the like. Preferably, the memory of each RFID tag 19 is encoded with (or preprogrammed) with a unique code or vehicle identifier that identifies the particular vehicle into which it is incorporated. In one embodiment, the unique code is the vehicle identification number (“VIN”). In other embodiments, the unique code can be any suitable identifier such as any unique number encoded on the tag or a unique code of any combination of alphanumeric characters. When the system 10 is used by a car dealership, the dealer can include an RFID tag having a unique code in each vehicle it sells and/or services. When the system 10 is used by a service provider other than a car dealership, the service provider can attach the RFID tag to the customer's vehicle. Alternatively, the service provider can provide the customer with an RFID tag with the unique identifier encoded on it and with instructions of where and how to secure the RFID tag to his/her vehicle.

Also, in a typical commercial embodiment, the RFID tag is attached to the backside of the vehicle's rearview mirror (i.e., the side facing the windshield), although the RFID tag can be attached at any suitable location in or on the vehicle. For example, the RFID tag can be attached to a window, a side mirror, windshield, hood, etc. Preferably, the tag is glued or otherwise adhered to the vehicle, although other suitable fasteners and fastening techniques can be used to attach the RFID tag to the vehicle.

One or more suitable RFID sensor/readers 17 are placed in appropriate areas of the dealership or service area so as to receive the data (i.e., unique code) transmitted from the passive RFID tag. RFID readers are generally well known and their configurations will not be discussed in detail herein. Preferably, the RFID sensor 17 also includes a transceiver for transmitting received data to the server 11.

Preferably, the RFID sensor 17 and the optional video camera 15 are located near the entry of a service area (such as, for example, the entry to a vehicle dealership, mechanic's garage, drive-thru window, or carry-out service), although one or more RFID readers can be placed at any suitable location at the car dealership or service area. Both the video camera 15 and the RFID sensor 17 are positioned such that video camera 15 will capture images of vehicles entering the service area while the RFID sensor 17 is aligned such that its emission of radio waves will “see” the RFID tags. In an alternative embodiment, the video camera and the RFID sensor can be housed within a single housing. In a typical commercial embodiment, the location of the video camera and the RFID sensor are remote from the server 11 and are generally positioned at the entryway to the service provider (such as secured to the frame of a service bay entrance or other appropriate area of the service provider).

The server 11 includes applications and a database 12. The server 11 can run administrative software for a computer network and controls access to itself and database 12. Preferably, the database 12 includes a list of the vehicles tagged with RFID tags as well as associated customer information and vehicle information. Such customer information can include, but is not limited to, the customer's name, contact information (e.g., home address, phone numbers, email addresses, etc.), and balance due (such as the amount of money owed the dealership for services or the amount due to a note holder). Vehicle information can include, but is not limited to, the year, make, color, and model of the vehicle, the options purchased, the vehicle service history, and one or more photographs of the vehicle. Any additional suitable information can also be stored in the database. Additional information can include, but is not limited to, recommended services or recommended items for purchase.

Optionally, one or more “third party” systems 23 and databases 24 can be accessed by the server 11 in order to obtain vehicle and customer information for dissemination to remote devices. Data that is obtained from third party computer system 23 and database 24 can be stored on the server 11 in order to provide later access to the remote user devices 21. It is also contemplated that for certain types of data that the remote user devices 21 can access the third-party data directly using the network 13. In other words, in some embodiments, other dealerships, mechanics, and service providers can access the database 12 of customer and vehicle information.

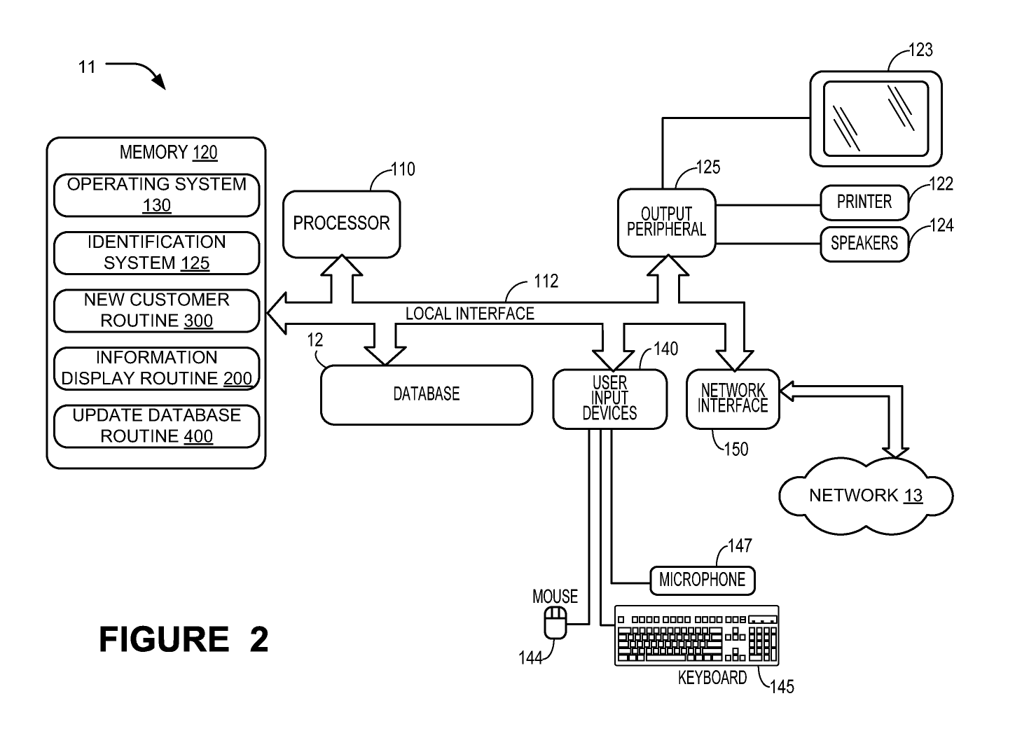

Illustrated in FIG. 2 is a block diagram demonstrating an example of server 11, as shown in FIG. 1. The server 11 includes, but is not limited to, one or more of a personal computer (PC), workstation, laptop, personal digital assistant (PDA), palm device, and the like. Generally, in terms of hardware architecture, as shown in FIG. 2, the server 11 includes a processor 110 and memory 120.

The server 11 further includes one or more user input devices 140 through which a user may enter commands and data and output devices. The input and output (I/O) devices can be connected to the processor 110 through a local interface 112. The local interface 112 can be, for example but not limited to, one or more buses or other wired or wireless connections, as is known in the art (such as a parallel port, game port, or a universal serial bus (USB)). The local interface 112 may have additional elements, which are omitted for simplicity, such as controllers, buffers (caches), drivers, repeaters, and receivers, to enable communications. Further, the local interface 112 may include address, control, and/or data connections to enable appropriate communications among the aforementioned components.

The processor 110 is a hardware device for executing software that can be stored in the memory 120. The processor 110 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 120 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 120 may incorporate electronic, magnetic, optical, and/or other types of storage media. Note that the memory 120 can have a distributed architecture, where various components are situated remote from one another, but can be accessed by the processor 110.

The software in memory 120 can include one or more separate programs, each of which comprises an ordered listing of executable instructions for implementing logical functions. In the example illustrated in FIG. 2, the software in the memory 120 includes a suitable operating system (O/S) 130, the RFID identification routine 125 of the present invention, an information display routine 200, a new customer routine 300, and an update database routine 400.

A non-exhaustive list of examples of suitable commercially available operating systems 130 is as follows (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 130 essentially controls the execution of other computer programs, such as the RFID identification routine 125, and provides scheduling, input-output control, file and data management, memory management, and communication control and related services. However, it is contemplated by the inventors that the RFID identification routine 125 of the present invention is applicable on all other commercially available operating systems.

The RFID identification routine 125 and routines 200, 300, and 400 may be a source program, executable program (object code), script, or any other entity comprising a set of instructions to be performed. When a source program, the program is usually translated via a compiler, assembler, interpreter, or the like, which may or may not be included within the memory 120, so as to operate properly in connection with the O/S 130. Furthermore, the RFID identification routine 125 and routines 200, 300, and 400 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 144 (or other pointing device such as a trackball or touchpad), keyboard 145, microphone 147, scanner (not shown), electronic digitizer (not shown), joystick (not shown), game pad (not shown), satellite dish (not shown), scanner (not shown), etc. Furthermore, the I/O devices may also include output devices, for example but not limited to, a printer 122, display 123, speakers 124, etc. Finally, the I/O devices may further include devices that communicate both inputs and outputs, for instance but not limited to, a NIC 150 or modulator/demodulator (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device, or the like, the software in the memory 120 may further include a basic input output system (BIOS) (omitted for simplicity). The BIOS is a set of essential software routines that initialize and test hardware at startup, start the O/S 130, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 110 is configured to execute software stored within the memory 120, to communicate data to and from the memory 120, and to generally control operations of the server 11 are pursuant to the software. The RFID identification routine 125, and routines 200, 300, and 400, and the O/S 130 are read, in whole or in part, by the processor 110, perhaps buffered within the processor 110, and then executed.

When the RFID identification routine 125 and routines 200, 300, and 400 are implemented in software, as is shown in FIG. 2, it should be noted that the RFID identification routine 125 can be stored on virtually any computer readable medium for use by or in connection with any computer related system or method. The RFID identification routine 125 and routines 200, 300, and 400 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, contain, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the RFID identification routine 125 is implemented in hardware, the RFID identification routine 125 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

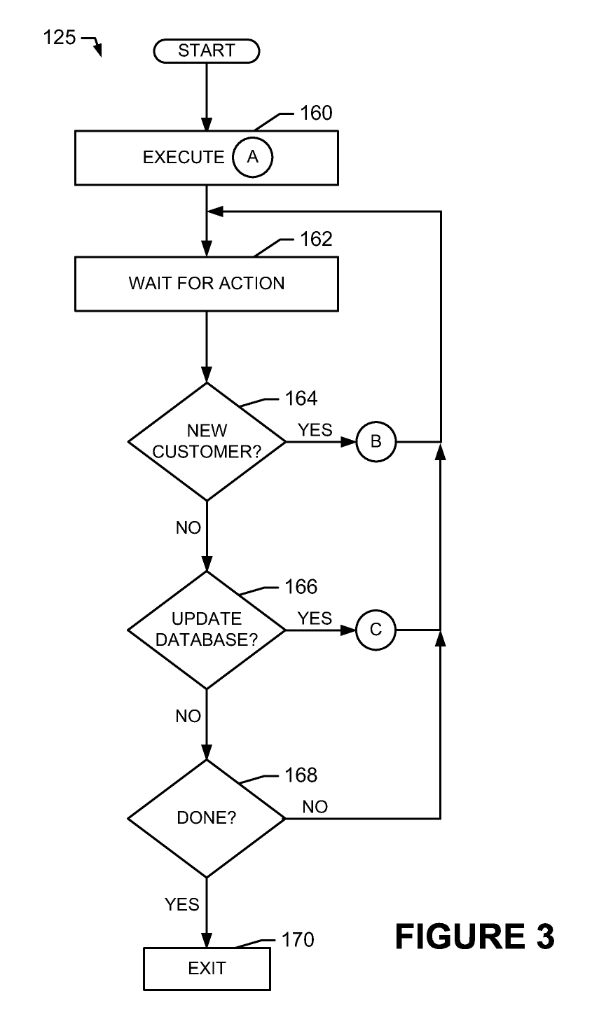

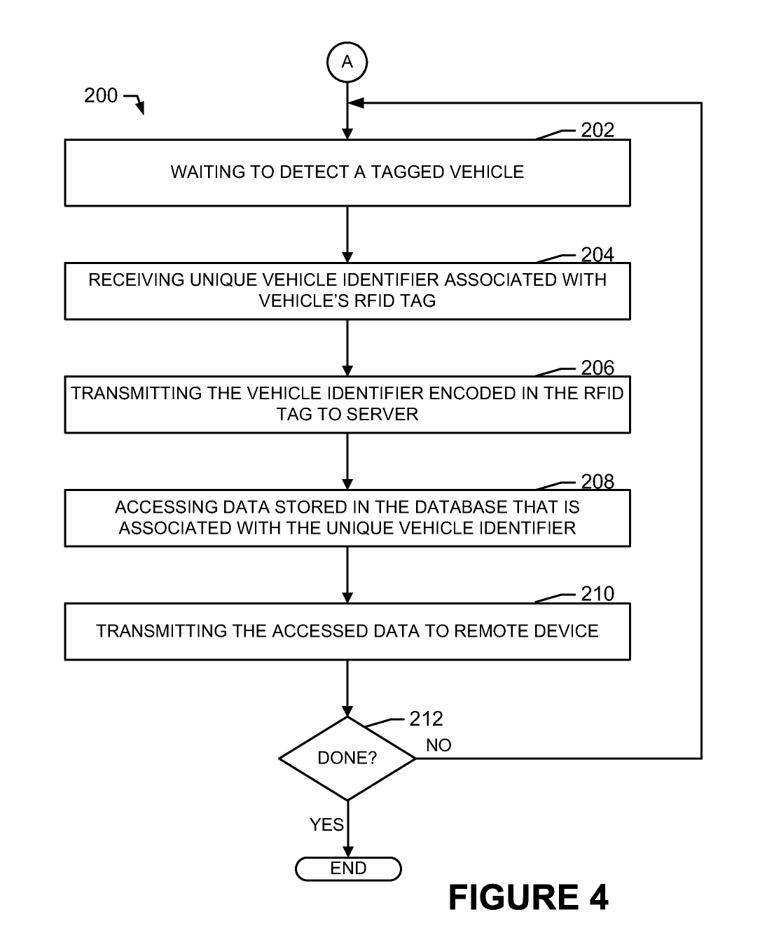

As described in FIG. 3, the RFID identification routine 125 includes several routines, including the information display routine 200, the new customer routine 300, and the update database routine 400. Beginning at step 160, the information display routine 200 is executed. Such usually occurs when a system operator turns on or activates the system 10, including the RFID reader 17 and/or computer server 11. As described in FIG. 4, the information display routine 200 begins at step 202 when the RFID reader 17 of the system is waiting to detect a vehicle tagged with an RFID tag 19 passing within its zone. At step 204, the RFID reader receives the unique vehicle identifier data from the RFID tag when a tagged vehicle is detected. As discussed herein, in a typical commercial embodiment, the RFID reader is placed near the entrance to the service provider so that as the vehicle enters the service provider's area, the presence of the vehicle is detected. Optionally at this step, the video camera also captures images of the vehicle entering the service provider area and streams the video to one or more remote devices (such as one or more display screens). As is well known in the art, the RFID reader emits radio waves that when encountered by the passive RFID tag form a magnetic field. The RFID tag draws power from the magnetic field, energizes its circuits, and transmits the unique vehicle identifier encoded within its memory to the RFID reader. At step 206, the RFID reader transmits the unique vehicle identifier data to the server 11 via the network 13. At step 208, the server 11 accesses the data (e.g. the customer and vehicle information) in the database 12 that is associated with the unique vehicle identifier. At step 210, the server 11 transmits the customer and vehicle data from the database to one or more remote devices. For example, the transmission to a remote device can include transmitting a text message to a cellular phone or PDA, an email to a remote device capable of receiving email, an instant message to a computer, cellular phone or PDA, or other transmission to a user of the system (such as a service associate or other designated person) or to a central messaging service. In an example embodiment, the data can be transmitted to a display screen of the receptionist or other greeter as a “pop-up” message. Alternatively or additionally, a message can be sent directly to a service associate that is predetermined to receive messages from a particular uniquely identified vehicle. For example, if a vehicle/customer was previously assigned to a particular service technician, the information can be transmitted to a remote device associated with that particular technician. In such an embodiment, the database includes information about where to transmit the data, and the routine 200 includes instructions to transmit the data to the remote device associated with the unique code in the database. In other embodiments, it may be advantageous to also notify the sales associate who sold the customer the vehicle so as to maintain customer relations. At step 212, the system determines if the routine 200 is done. If not, the routine 200 loops back to step 202 where the system is waiting to detect a tagged vehicle. If the routine is done (such as when the operator turns off the system), the routine 200 ends.

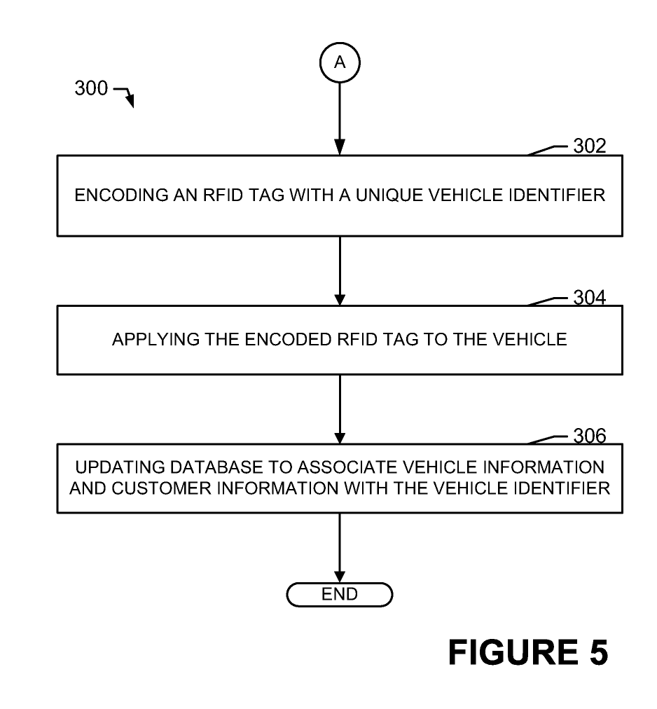

After executing the display information routine 200, the system waits for an action at step 162. One an action is detected, then at step 164, a decision is made to determine if the customer is a new customer. If the answer is yes, the new customer routine 300 is called. As described in FIG. 5, the new customer routine 300 begins at step 302 when appropriate personnel associated with the service provider encodes the memory of the RFID tag with the unique vehicle identifier. At step 304, the encoded RFID tag is secured to the vehicle, such as by adhering it to the rear side of the rearview mirror. In a typical commercial embodiment, this tagging occurs prior to when the vehicle is sold by the dealership, although this step of tagging the vehicle can occur at any suitable time. Alternatively, an untagged vehicle can be tagged with an RFID tag at any time the vehicle is on the lot or at the service area (such as the first time the vehicle is serviced). At step 306, the database 12 storing customer information is updated to include the unique vehicle identifier, the customer information and the vehicle information, as well as any additional information that the service provider desires to include. The routine 300 ends and loops back to step 162 where the system is waiting for the next action.

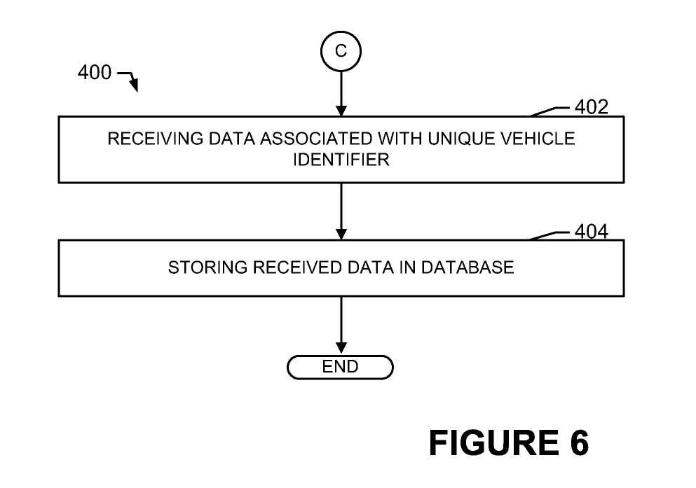

If at step 164, the decision is that the customer is not a new customer, the routine proceeds to step 166 where another decision is made to determine if the database 12 is to be updated. If the decision is to update the database, the update database routine 400 is called. As described in FIG. 6, at step 402 data associated with a unique vehicle identifier is received by the database 12. Such data can include customer information, vehicle information, and any additional information. For example, a user of the system may choose to update the database after a vehicle is serviced so as to maintain an up-to-date service history. In other instances, the database may be updated when a balance is paid or at any other appropriate time as desired by a user of the system. At step 404, the data is stored by the database for future use. The routine 300 ends and loops back to step 162 where the system is waiting for the next action.

Referring back to FIG. 3, another decision is made at step 168 to determine if the routine is done. If the decision is no, then the RFID identification routine 125 loops back to step 162 where it is waiting for the next action. If, however, the decision is yes, the routine 125 ends.

Those skilled in the art will understand that the systems and methods of the present invention can be used by any service provider, including those providing restaurant, catering, and retail services. For example, a provider of restaurant or retail services can utilize the system to identify the customer arriving to the service area and to track customer preferences. For example, such can be advantageous when the customer is picking up food or other items. The system can automatically identify the customer without any input from him and provide a prearranged service. In one embodiment, the customer can register on the service provider's website, and the service provider can mail the customer the RFID tag with the encoded identifier and instructions to attach the RFID tag to his/her vehicle. Customer preferences can be associated with the unique number and stored in the database. For example, if the service provider is a restaurant, the customer preferences can include the preferred food and drinks and preferred time for service. Other suitable customer preferences can be stored in the database as well.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In addition, those skilled in the art will appreciate that the mechanisms of the subject matter described herein are capable of being distributed as a program product in a variety of forms, and that an illustrative embodiment of the subject matter described herein applies regardless of the particular type of computer readable medium used to actually carry out the distribution.

While various aspects and embodiments have been disclosed herein, it will be understood by those skilled in the art that a variety of modifications, additions, and deletions are within the scope of the invention, as defined by the following claims.

1. A method for notifying a service provider of the arrival of a vehicle, comprising:
determining a unique vehicle code that is associated with the arriving vehicle;
transmitting the unique vehicle code to a computer system having an associated database;
accessing data stored in the database that corresponds to the unique vehicle code; and
displaying the data on a display screen.

2. The method of claim 1, wherein the display screen is a screen of a remote user device.

3. The method of claim 1, wherein the step of determining a unique code further comprises determining the unique code encoded in a radio frequency identification tag secured to or within the vehicle.

4. The method of claim 1, wherein the step of displaying of data on a display screen includes sending a text message or email message to a user device.

5. The method of claim 1, wherein the step of transmitting the data includes transmitting the data over a wireless communications network.

6. The method of claim 1, wherein the step of accessing data stored in the database includes accessing customer and vehicle information.

7. A system for notifying a service provider of the arrival of a vehicle, comprising:
a radio frequency identification (RFID) reader having an associated transceiver, wherein the RFID reader receives a transmission of a unique vehicle identification code from an RFID tag that is secured to the vehicle; and
a computer system, wherein the computer system receives the unique code transmitted from the RFID reader, accesses a database for data associated with the unique code, and displays the associated data on a display device, wherein the displayed data includes data about the customer and/or vehicle associated with the unique code.

8. The system of claim 7, wherein the unique code is a vehicle identification number.

9. The system of claim 7, wherein the display device includes a display screen, a computer, a cellular phone, or a personal digital assistant.

10. The system of claim 7, further comprising a video camera, wherein the video camera captures video of the vehicle and streams the video the display device.

11. The system of claim 7, further comprising a remote computer system, wherein the remote computer system communicates with the computer system via a wireless communications network to access data in the database.

12. A computer readable medium having a computer program for notifying a service provider of the arrival of a vehicle, the program comprising:
executable instructions for determining a unique vehicle code that is associated with the arriving vehicle;
executable instructions for transmitting the unique vehicle code to a computer system having an associated database;
executable instructions for accessing data stored in the database that corresponds to the unique code; and
executable instructions for displaying the data on a display screen.

13. The computer readable medium of claim 12, wherein the executable instructions for determining a unique code further comprises executable instructions for determining the unique code encoded in a radio frequency identification tag secured to or within the vehicle.

14. The computer readable medium of claim 12, wherein the executable instructions for displaying of data on a display screen includes executable instructions for sending a text message or email message to a user device.

15. The computer readable medium of claim 12, wherein the executable instructions for transmitting the data includes executable instructions for transmitting the data over a wireless communications network.

16. The computer readable medium of claim 12, wherein the executable instructions for accessing data stored in the database includes accessing customer and vehicle information.
